(19) United States
(12) Patent Application Publication
(10) Pub. No.: US 2003/0026567 A1
(43) Pub. Date: Feb. 6, 2003

(54) Graded index fiber, array and method of manufacture

(75) Inventors: Colm V. Cryan, Charlton, MA (US); Karim Tatah, Winchester, MA (US); Richard Strack, Sturbridge, MA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Schott Communications Technologies, Inc., Southbridge, MA (US)

(21) Appl. No.: 09/921,113

(22) Filed: Aug. 1, 2001

(51) Int. Cl. G02B 6/18

(52) U.S. Cl. 385/124

(57) ABSTRACT

A graded index fiber formed of a plurality of fused graded index fibers is provided. Each fiber is formed from a preform comprising a plurality of fused low index rods with at least one high index rod arranged in a pre-determined pattern which have been drawn and fused. An array may be made utilizing such fibers, with each fiber having a center located at a specified position. A method of forming the GRIN fibers and the GRIN fiber array is also provided.

### BACKGROUND

The present invention relates to a graded index fiber, an array of such fibers, and more particularly, to an array of graded index fibers that are packed in a regular structure for use as a fiber optic faceplate, an image conduit or a flexible image bundle.

Graded index fibers which are used as an optical conductor are known. Typically, such optical conductors utilize a core having a high refractive index at the center which decreases as a function of the distance away from the center. One known method of fabricating a stepped graded index fiber is to utilize telescoping tubes having different indices which are placed around a central core and fused together. However, it would be desirable to have more control over the refractive index profile of a fiber.

It would also be desirable to make an array using GRIN fibers. One known reference discloses the formation of an image guide utilizing microfibers having a size of approximately 5 microns down to approximately 1 micron. The GRIN fibers are bundled together and heated to form a fused boule of solid fibers. The solid boule is then placed in a heating chamber of a drawing tower in which the lower part of the boule is continuously heated and drawn down to a uniform diameter multi-microfiber image guide. The GRIN fibers may be formed from glass or a polymeric material. However, the variation of refractive index as a function of radius is achieved by radially dependent doping or for a plastic GRIN fiber, is made using two missable polymers with different refractive indices whose relative concentrations vary radially to produce the desired refractive index profile.

It would be desirable to provide a simpler method of producing a GRIN fiber with a desired fiber refractive index profile. It would also be desirable to provide a GRIN fiber array having a precision arrangement of GRIN fibers for use in applications such as fiber optic faceplates used as windows for an active device such as a VCSEL emitter or a CCD receiver as well as PD arrays.

### SUMMARY

Briefly stated, the present invention is directed to a graded index fiber formed from a preform comprising a plurality of fused low index rods with at least one high index rod arranged in a pre-determined pattern which have been drawn and fused.

In another aspect, the invention provides an array made from such GRIN fibers. A plurality of the GRIN fibers are provided, with each fiber have a center located at a specified position in the array.

In another aspect, the present invention provides a method of making a graded index fiber. The method includes:

arranging a plurality of low index rods and a plurality of high index rods in a predetermined pattern to form a GRIN fiber preform;

heating the GRIN fiber preform;

drawing and fusing together the GRIN fiber preform of the low index and the high index rods such that relative positions of the low index and high index rods are maintained.

In another aspect, the present invention provides a method of making a graded index fiber array. The method includes:

arranging a plurality of low index rods and a plurality of high index rods in a predetermined pattern to form a GRIN fiber preform;

heating the GRIN fiber preform;

drawing and fusing together the GRIN fiber preform of the low index and the high index rods such that relative positions of the low index and high index rods are maintained to form a GRIN fiber;

arranging a plurality of the GRIN fibers in a preselected pattern; and

fusing the GRIN fibers together into an array.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements shown.

FIG. 1A is a greatly enlarged cross-sectional view of a GRIN fiber preform for use in making a graded index fiber in accordance with a first preferred embodiment of the present invention.

FIG. 1B is a diagram showing the refractive index distribution of the GRIN fiber formed from the preform of FIG. 1A.

FIG. 2A is a greatly enlarged cross-sectional view of a GRIN fiber preform which can be used in a graded index fiber in accordance with a second preferred embodiment of the present invention.

FIG. 2B is a diagram showing the refractive index distribution of the GRIN fiber formed from the preform of FIG. 2A.

FIG. 3A is a greatly enlarged cross-sectional view of a GRIN fiber preform for a graded index fiber in accordance with a third preferred embodiment of the present invention having a mode selective distribution.

FIG. 3B is a diagram showing the refractive index distribution for the GRIN fiber formed from the preform of FIG. 3A.

FIG. 4 is a greatly enlarged cross-sectional view of a GRIN fiber preform for a graded index fiber in accordance with a fourth preferred embodiment of the invention.

FIG. 5 is a cross-sectional view of a graded index fiber array in accordance with the first preferred embodiment of the invention utilizing the graded index preform of FIG. 1.

FIG. 6 is a graded index fiber array having an offset stacking of the fibers.

FIG. 7 is a cross-sectional view of a graded index fiber array in accordance with the present invention having a square pack arrangement.

### DETAILED DESCRIPTION OF THE PREFERRED EMBODIMENTS

Certain terminology is used in the following description for convenience only and is not considered limiting. The words “right”, “left”, “lower” and “upper” designate directions in the drawings to which references made. This terminology includes the words specifically noted above, derivatives thereof and words of similar import. Additionally, the terms “a” and “one” are defined as including one or more of the referenced item unless specifically noted. The term “array” as used herein is intended to include any type of two-dimensional arrangement of fiber ends, such as for a fiber optic faceplate, an image conduit or a flexible image bundle.

Referring now to FIGS. 1A and 1B, a schematic diagram of the cross-section of a graded index (GRIN) fiber preform 10 for forming a GRIN fiber is shown. The preform 10 is assembled from multiple rods 11, 12, 13, 14, 15, 16 with different refractive indices. One or more of the low index rods 11, 12, 13, 14 and at least one high index rod 16, are arranged in a predetermined pattern in order to provide the desired refractive index profile. The preform is heated and drawn in the known manner in order to form a GRIN fiber. Preferably, the GRIN fiber has a diameter of approximately 50 microns. However, the GRIN fiber may be drawn to different final sizes depending on the desired use for the GRIN fiber. It is also possible to provide precision drawing equipment with feedback on the diameter of the drawn fiber in order to form a GRIN fiber having very precise dimensions that are constant to within 0.5 microns along the length of the fiber.

As shown in FIG. 1B, the refractive index profile for the GRIN fiber formed by the preform 10 is a stepped profile which approximates the a curve profile associated with GRIN fibers known in the prior art. However, through the selection and placement of different rods 11-16, any desired profile can be constructed.

While the first embodiment of the preform 10 includes rods 11-16 having six different indices of refraction, as explained in detail below, all that is required is a plurality of low index rods and at least one high index rod arranged in the pre-determined pattern in order to achieve the desired profile. The refractive indices of the material preferably vary from approximately 1.3 to approximately 1.9. However, higher or lower refractive index materials may be utilized, if desired.

In the preferred embodiment, the rods 11-16 are made of glass. However, it will be recognized by those skilled in the art from the present disclosure that the rods may be made of a polymeric materials. For example, the rods could be made from polymers such as PMMA and TEFLON®, or other suitable materials.

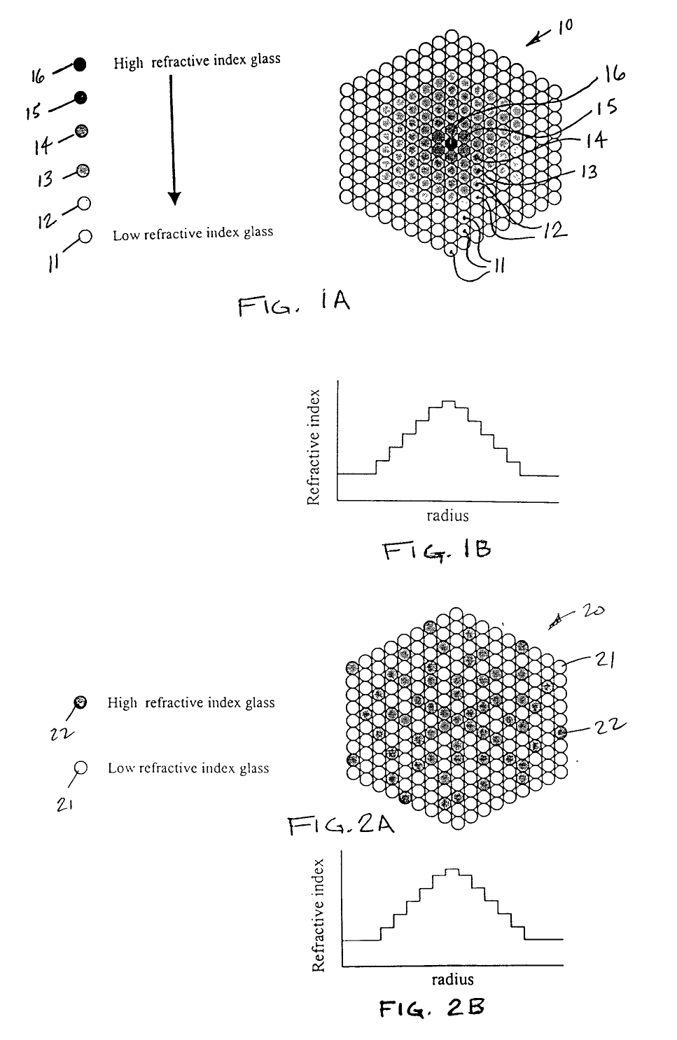

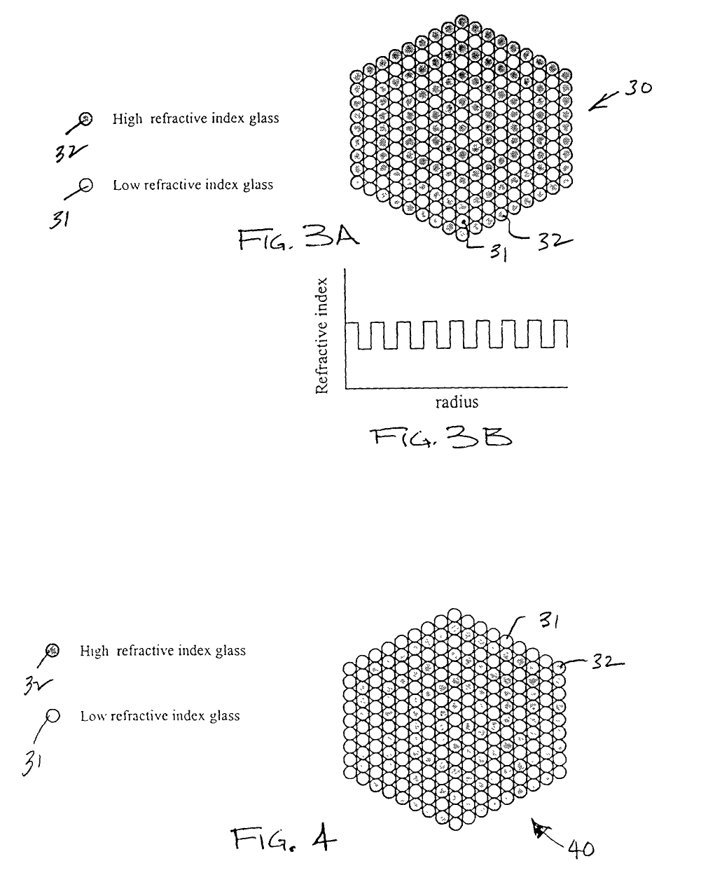

Referring now to FIGS. 2A and 2B, a schematic diagram of a second GRIN fiber preform 20 is shown. The preform 20 comprises a plurality of low index rods 21 and at least one high index rod 22. Preferably, the low index and high index rods 21, 22 are glass. However, those skilled in the art will recognize from the present disclosure that the low index and high index rods may be formed of a polymer. As shown in FIG. 2, the low index and high index rods 21, 22 are arranged using a statistical distribution to provide a desired refractive index distribution, as shown in FIG. 2B. The refractive index distribution can be adjusted by statistical means utilizing only two types of rods in order to achieve a desired refractive index profile across the preform 20. The low index rods and high index rods are arranged in a pre-determined pattern to form the preform. The preform 20 is heated and drawn in order to fuse the arrangement of low index and high index rods 21, 22 together such that the relative position of the low index and high index rods 21, 22 is maintained to form a GRIN fiber. Preferably, the final GRIN fiber produced from the preform 20 has a diameter of about 125 microns. However, those skilled in the art will recognize from the present disclosure that other diameters may be formed.

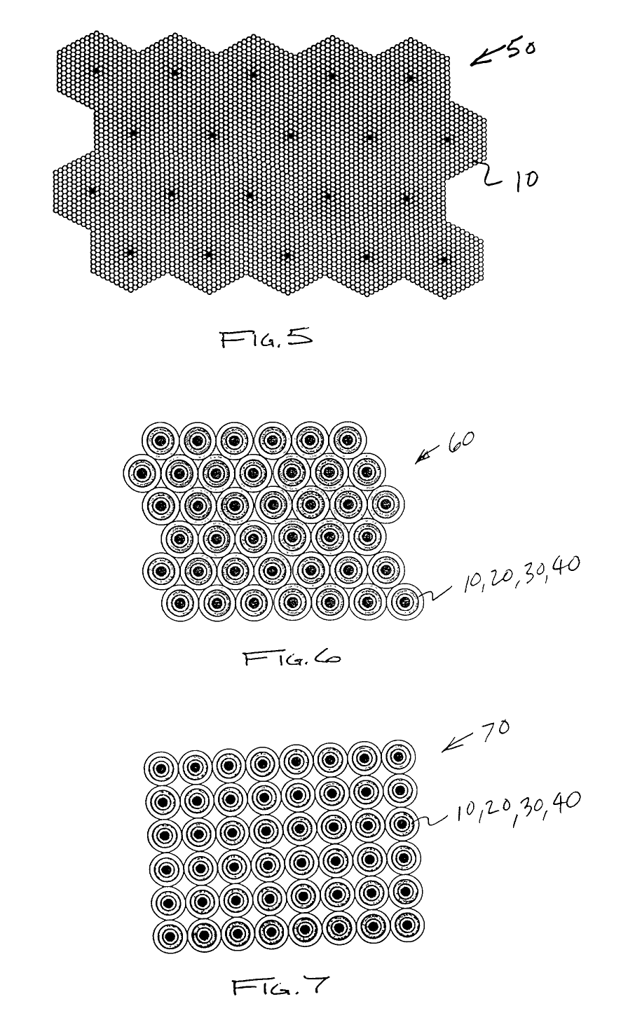

Referring now to FIGS. 3A and 3B, an alternate arrangement of the low index and high index rods 31, 32 is shown for a GRIN fiber preform 30. This arrangement provides a mode selective distribution with a refractive index profile as shown in FIG. 3B. An alternate arrangement of a mode selective GRIN fiber preform 40 is shown in FIG. 4.

Referring now to FIG. 5, a plurality of the GRIN fibers, such as those formed from the preforms 10, 20, 30 or 40, or a mixture thereof, are stacked in a desired arrangement and fused together in order to form a graded index fiber array 50. This is done in a manner generally known to those skilled in the art. The plurality of GRIN fibers each have a center located at a specified position, such as a spacing of 125 microns for use in connection with active devices such as CCD receptors, VCSEL emitters and PD arrays and can be used in place of standard fiber optic faceplates as windows. The fused array can be cut into pieces of a desired length and the ends polished to form a faceplate. Alternatively, the fused array can be drawn to a smaller size, if desired, to form an image conduit or flexible image bundle.

The GRIN fiber array 50 offers the advantage of an increased standoff distance, i.e. the distance between the active device surface and the surface of the faceplate. Faceplates are used in order to transmit an image into a plane on the other face of the array. The preforms may be arranged in various patterns, such as shown in FIGS. 6 and 7 in order to form arrays having varying numbers of GRIN fibers, with each GRIN fiber being formed by one of the preform 10, 20, 30, 40, as discussed above. While a preferred arrangement includes a 20×20 square pack with the GRIN fibers located at a pitch of 125 microns, those skilled in the art recognize that other fiber counts, packing structures and pitches could be used, if desired.

By using the GRIN fibers of the present invention, new properties, including increased bandwidth, mode control and focusing are provided which were not available in accordance with the prior known GRIN fibers. This is achieved due to the use of the low index and high index rods which are used to form the preform being arranged in a predetermined pattern in order to provide the desired properties from the GRIN fiber created from the preform.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A graded index fiber comprising:
a drawn and fused preform comprising a plurality of low index rods and at least one high index rod arranged in a predetermined pattern.

2. The graded index fiber of claim 1, wherein the preform includes intermediate index rods arranged in a predetermined pattern with the low index rods and the at least one high index rod.

3. The graded index fiber of claim 2, wherein the intermediate index rods have at least two different indices that are between an index of the low index rods and an index of the at least one high index rod.

4. The graded index fiber of claim 1, wherein the low index and high index rods are arranged using a statistical distribution to provide a desired refractive index distribution.

5. The graded index fiber of claim 1, wherein the low index and high index rods are glass.

6. The graded index fiber of claim 1, wherein the low index and high index rods are formed of a polymer.

7. A graded index fiber array comprised of a plurality of graded index fibers in accordance with claim 1, wherein each graded index fiber has a center located at a specified position.

8. The graded index fiber array of claim 7, wherein the array includes a plurality of graded index fibers arranged in an m x n array.

9. The graded index fiber array of claim 8, wherein the fused GRIN fibers are located at a predetermined pitch.

10. A method of making a graded index fiber, comprising:
arranging a plurality of low index rods and a plurality of high index rods in a predetermined pattern to form a preform;
heating the preform of the low index and high index rods;
drawing and fusing together the preform of low index and high index rods such theat the relative position of the low index and high index rods is maintained.

11. The method of claim 10 further comprising:
arranging a plurality of intermediate index rods in a predetermined pattern with the low index and high index rods.

12. The method of claim 11 further wherein the low index, intermediate index and high index rods are arranged using a statistical distribution to provide a desired refractive index distribution for each of the GRIN fibers.

13. The method of claim 10 wherein the low index and high index rods are arranged using a statistical distribution to provide a desired refractive index distribution.

14. A method of making a graded fiber index array, comprising
arranging a plurality of low index rods and a plurality of high index rods in a predetermined pattern to form a preform;
heating the preform of the low index and high index rods;
drawing and fusing together the preform of low index and high index rods such theat the relative position of the low index and high index rods is maintained to form a GRIN fiber;
arranging a plurality of the GRIN fibers in a preselected pattern; and
fusing the GRIN fibers together into an array.
